(19) United States
(12) Patent Application Publication
(10) Pub. No.: US 2007/0212489 A1
(43) Pub. Date: Sep. 13, 2007

(54) Method for compensating for any of shortage and excess of sealant dispensed on a substrate

(76) Inventors: Youn-jung Joo, Paju-Si (KR); Kyu-yong Bang, Paju-si (KR); Jong-sang Kim, Paju-si (KR)

Correspondence Address: KED & ASSOCIATES, LLP, P.O. Box 221200, Chantilly, VA, 20153-1200, US

(21) Appl. No.: 11/709,877

(22) Filed: Feb. 23, 2007

(30) Foreign Application Priority Data
Feb. 24, 2006 (KR) 10-2006-0018237
Jan. 31, 2007 (KR) 10-2007-0010154

(51) Int. Cl. B05D 5/00

(52) U.S. Cl. 427/256

(57) ABSTRACT

There are provided a method for calculating an amount of liquid crystal to compensate for any of shortage and excess of sealant dispensed on a substrate, Include putting the substrate on a stage, dispensing the sealant in a predetermined pattern on the substrate using a dispensing head, detecting an out-of-specification portion of the pattern of sealant and calculating a cubage of the out-of-specification portion of the pattern of sealant, and calculating any of shortage and excess of sealant due to the out-of-specification of the pattern of sealant. The liquid crystal dispenser adjusts a reference amount of liquid crystal to be dispensed, according to the data provided from the controlling unit of the sealant dispenser. This prevents the liquid crystal from being excessively dispensed, thereby overflowing over the pattern of sealant, or from being insufficiently dispensed.

### CROSS REFERENCE TO RELATED APPLICATION

This application claims the benefit of and priority to Korean Patent Application Nos. 2006-18237, filed on Feb. 24, 2006, and 2007-10154, filed on Jan. 31, 2007, which are hereby incorporated by reference for all purposes as if fully set forth herein.

### BACKGROUND OF THE INVENTION

1. Field of the Invention

The present invention relates to a method for calculating an amount of liquid crystal to compensate for any of shortage and excess of sealant dispensed on a substrate by calculating a cubage of an out-of-specification portion of a pattern of sealant formed on the substrate

2. Description of the Background Art

A liquid crystal display (LCD) is low in power consumption, relatively small in size, and excellent in image quality, compared to a bulky cathode ray tube (CRT) of the same screen size. The LCD has established a firm foothold on the market as a flat panel display for computers, transportation, communication, instrumentation and, with increasing importance for television.

A thin film transistor (TFT) LCD consists of a TFT array substrate and a color filter array substrate. The two are separated by 4-5 μm and form the sandwich for the liquid crystal layer. At the periphery of the display viewing area, a glue seal bonds the two substrates together and also prevents moisture and contamination from entering the LC fluid.

A sealant dispenser dispenses a sealant, which serves to bond the two substrate, in a predetermined pattern on one of the substrate.

The sealant dispenser includes a stage on which the substrate is put, a dispensing head on which to provide a nozzle through which the sealant is dispensed, a head supporting frame on which to provide the dispensing head, and a controlling unit controlling a motor moving the head-supporting frame and a motor moving the dispensing head

A syringe, which contains the sealant, is connected to the nozzle. Then the syringe connected to the nozzle is provided to the dispensing head.

The sealant dispenser forms a pattern of sealant on the substrate while changing a relative distance between the substrate and the nozzle.

That is, while the sealant is dispensed, the substrate is moved in one direction and the dispensing head on the head supporting frame is moved in the direction perpendicular to the direction in which the substrate is moved.

FIG. 1 is a perspective view illustrating a dispensing head of a conventional sealant dispenser. FIGS. 2 and 3 are side and top views illustrating how to inspect the pattern of sealant formed on the substrate.

The conventional sealant dispenser head 100, as shown in FIG. 1, includes a main block 102 provided to a head-supporting frame (not shown), a head block 104 on which to provide detachably a syringe containing the sealant. a moving unit 103 moving horizontally back and forth the head block 104 in the direction perpendicular to the head supporting frame, and a nozzle (not shown) provided to the lowest part of the head block 104.

The moving unit 103 (not shown) includes an linear movement apparatus having a servomotor and an motor axis connected thereto. The moving unit 103 moves horizontally back and forth the head block 104 in the direction perpendicular to the head supporting frame to set up a position of the nozzle (not shown) relative to the substrate.

A first Z-axis motor 107 is provided to a upper part of the main block 102. The first Z-axis motor 107 adjusts the position of the nozzle by moving the moving unit 103 vertically. A second Z-axis motor 108 is provided to the main block 102. The second Z-axis motor 108 accurately adjusts a height of the nozzle to set up the distance between the nozzle and the substrate. The height of the nozzle may be adjusted using only the first Z-axis motor 107 without having to provide the second Z-axis motor 108 to the main block 102.

The nozzle is laterally moved by moving the main block 102 along the head supporting frame.

first and second sensors 109a and 109b are provided to one side of the head block 104. The first sensor 109a is provided in front of the nozzle in the direction in which the sealant is dispensed. The first sensor 109a serves to detect a relative distance between the nozzle and the surface of the substrate while dispensing the sealant on the substrate. The dispensing of the sealant according to the relative distance between the nozzle and the surface of the substrate makes it possible to uniformly dispense the sealant on the substrate. The second sensor 109b serves to measure a cross-sectional area of the sealant dispensed in the specified pattern on the substrate.

A lens 109c is provided within the second sensor 109b to rotate from side to side. The second sensor 109b continuously emits a laser beam through the lens 109c toward the substrate “G” to scan the sealant “P”. Thus, the second sensor 109b serves to measure the cross-sectional area of the sealant dispensed on the substrate “G”.

A cross-sectional area at a predetermined point on the pattern of sealant is measured on the sample basis to inspect if a pattern of sealant is properly formed on the substrate.

When an out-of-specification pattern is not detected as a result of measuring the cross-sectional area at the predetermined point on the pattern of sealant, the substrate on which the pattern of sealant is formed is transferred to a liquid crystal dispenser (not shown). The liquid crystal is dispensed at regular intervals on the substrate in the liquid crystal dispenser.

However, the sealant may be dispensed more than or less than a reference amount because the pattern of sealant is improperly formed on the substrate, Subsequently, the liquid crystal dispenser dispenses a reference amount of the liquid crystal on the substrate without compensating for the excess or shortage of the sealant due to the out-of-specification pattern of sealant formed in the sealant dispenser. For example, after the sealant is dispensed more than would be properly on the substrate, when the reference amount of liquid crystal is dispensed, the liquid crystal will flow over the pattern of sealant in assembling the two substrates. This leads to the defects in the LCD.

### SUMMARY OF THE INVENTION

Therefore, an object of the present invention is to calculate an amount of liquid crystal to compensate for any of shortage and excess of sealant dispensed on a substrate by calculating a cubage of an out-of-specification portion of a pattern of sealant formed on the substrate.

According to an aspect of the present invention there is provided a method for compensating for any of shortage and excess of sealant dispensed on a substrate, the method including putting the substrate on a stage, dispensing the sealant in a predetermined pattern on the substrate using a dispensing head, detecting an out-of-specification portion of the pattern of sealant and calculating a cubage of the out-of-specification portion of the pattern of sealant, calculating any of shortage and excess of sealant due to the out-of-specification of the pattern of sealant, and providing information on any of shortage and excess of sealant to a liquid crystal dispenser.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a perspective view illustrating a dispensing head of a conventional sealant dispenser;

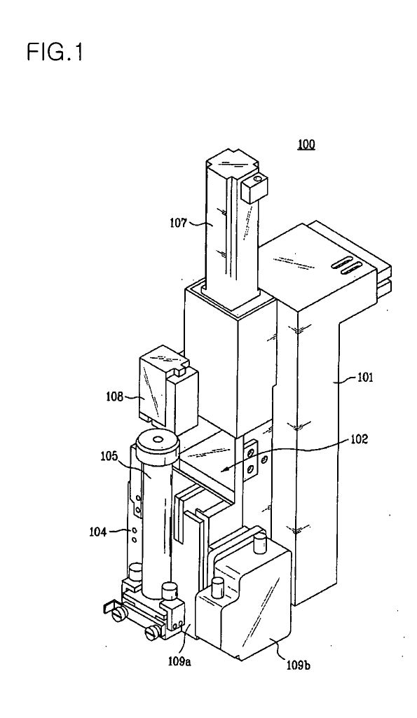

FIGS. 2 and 3 are side and top views illustrating how to inspect the pattern of sealant formed on a substrate through the use of a sensor provided to a head block of the conventional sealant dispenser.

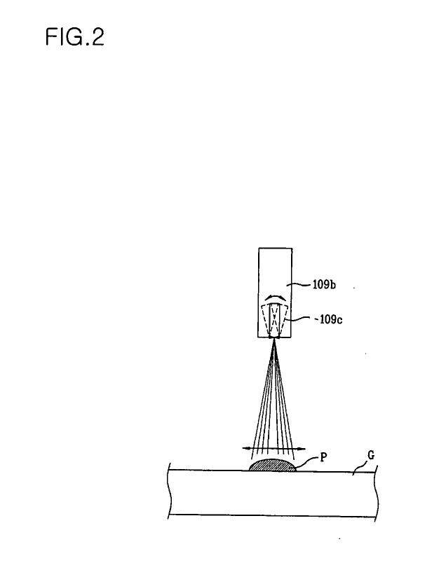

FIG. 4 is a perspective view illustrating a sealant dispenser according to the present invention.

FIG. 5 is a front view illustrating how to dispense a sealant through a dispensing head of the sealant dispenser according to the present invention.

FIG. 6 is a flow chart illustrating steps of calculating an amount of liquid crystal to compensate for any of shortage and excess of sealant dispensed on a substrate, according to the present invention;

FIG. 7 is a view illustrating an out-of-specification portion of the pattern of sealant where the shortage of sealant occurs; and

FIG. 8 is a view illustrating an out-of-specification portion of the pattern of sealant where the excess of sealant occurs.

### DETAILED DESCRIPTION OF THE INVENTION

The invention is described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present.

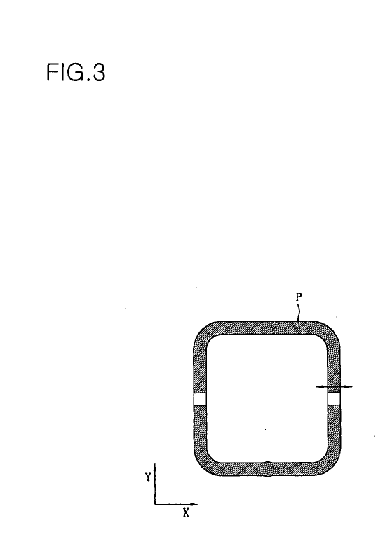

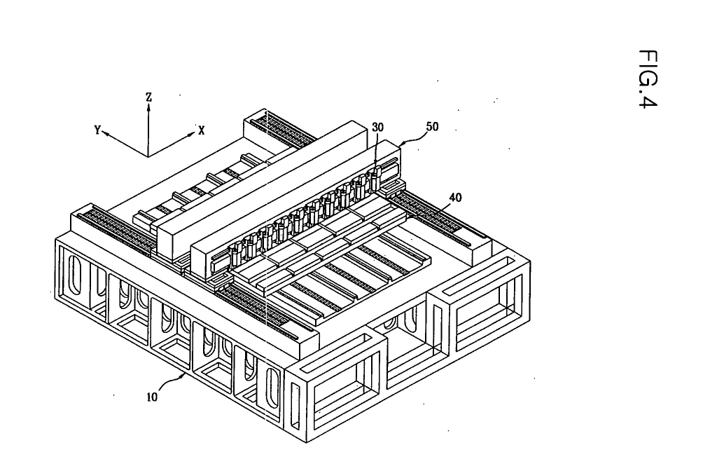

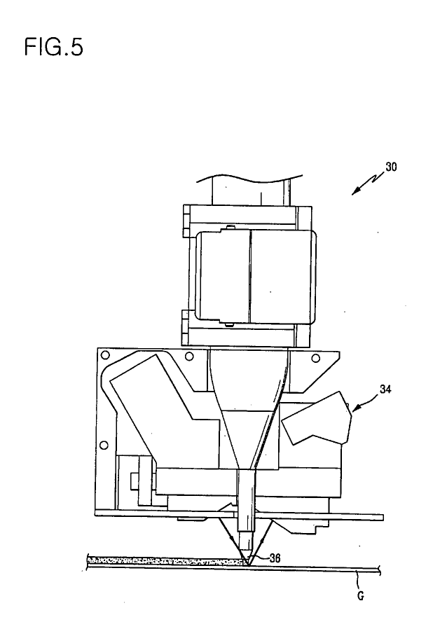

FIG. 4 is a perspective view illustrating a sealant dispenser. FIG. 5 is a front view illustrating how to dispense a sealant through a dispensing head of the sealant dispenser according to the present invention. FIG. 6 is a flow chart illustrating steps of calculating an amount of liquid crystal to compensate for any of shortage and excess of sealant dispensed on a substrate.

The sealant dispenser includes a body 10, a stage 40 provided to the body 10, on which the substrate is put, a stage-moving apparatus moving the stage 40 back and forth in the direction perpendicular to a head-supporting frame, a pair of head-supporting frames 50 which is moved back and forth along a length of the stage 10, a plurality of dispensing heads 30 provided to the head-supporting frame 50 to dispense the sealant on the substrate “G” and a controlling unit (now shown) connected to the dispensing head 30 to control an amount of sealant to be dispensed on the substrate.

The head-supporting frame 50 is a gantry-type frame. The dispensing head 30 includes a first sensor 34 measuring a distance between a nozzle through which to dispense the sealant and a surface of the substrate and a second sensor (not shown) measuring a cross-sectional area of the sealant dispensed on the surface of the substrate.

The process for dispensing the sealant on the substrate is now described.

The two head-supporting frames 50 are moved in the opposing directions to allow the substrate “G” to be put on the stage 50 through a space between the two head-supporting frames 50.

The substrate “G” is held on the stage by sucking air through openings (not shown) formed on the stage.

The two head-supporting frames return to their original positions when the substrate “G” is held on the stage.

Then, a distance between a surface of the substrate “G” and an end point of the nozzle 36 is set to a predetermined value.

Thereafter, the sealant is dispensed in the quadrangle pattern 20 on the surface of the substrate “G” while the stage 40 is moved by the stage moving apparatus in the direction perpendicular to the head-supporting frame and/or the dispensing head 30 on the head supporting frame 40 is moved along the head supporting frame.

The first sensor 34 is provided adjacent to the nozzle 36. The controlling unit (now shown), which is connected to the first sensor over wire or wireless, calculates the relative distance between the nozzle and the surface of the substrate “G” based on the data obtained by the first sensor 34. The relative distance is maintained while dispensing an amount of sealant through the nozzle. This enables an amount of sealant to be uniformly dispensed on the substrate.

The data on the relative distance, obtained from the first sensor 34, is transferred in real time to the controlling unit and stored there.

After dispending the sealant in the specific pattern on the substrate, it is inspected whether the sealant is properly dispensed according to the specification.

This is done by comparing a cross-sectional area of sealant at one point on the pattern of sealant with the reference cross-sectional area.

The second sensor scans across the specific point on the pattern of sealant, where the relative distance between the nozzle and the surface of the substrate is beyond the allowable range to enable the provide. The controlling unit calculates the cross-sectional area of sealant at the point based on data obtained from the second sensor. The second sensor may scan across a predetermined point on the pattern of sealant, where statically has a defect of high frequency.

When the cross-sectional area of sealant at the point is determined as being out of specification, the second sensor scans the out-of-specification portion of the pattern of sealant. The controlling unit calculates excess or shortage amount of sealant with respect to the out-of-specification portion of the pattern of sealant based on data obtained from the second sensor.

The controlling unit calculates an amount of liquid crystal which compensates for the excess or shortage amount of sealant. The controlling unit provides to a liquid crystal dispenser (now shown) data on the amount of liquid crystal to compensate for the excess or shortage amount of sealant. The liquid crystal dispenser adjusts a reference amount of liquid crystal to be dispensed, according to the data provided from the controlling unit of the sealant dispenser.

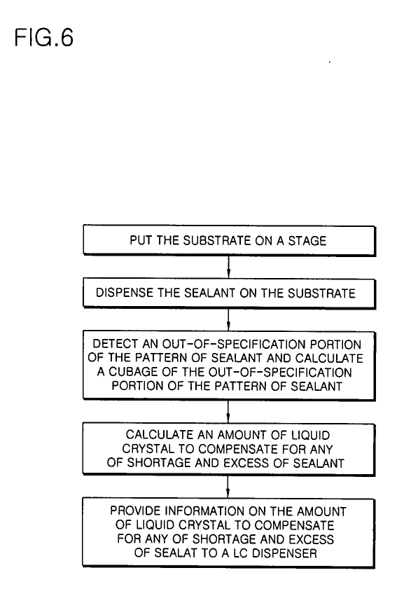

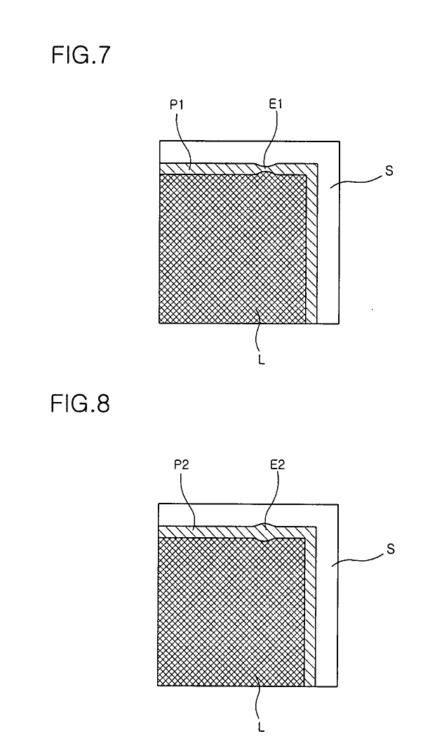

The out-of-specification portion of the pattern of sealant is shown in FIGS. 7 and 8. A pattern “P1”, as shown in FIG. 7, has the out-of-specification portion “E1” where the shortage of sealant occurs. This phenomenon happens when the distance between the nozzle 36 and the upper surface of the substrate “S” exceeds the predetermined reference distance, In this case, the controlling unit calculates a cubage of an inside retreating area where the sealant would have been dispensed, based on a cross-sectional area of the out-of-specification portion “E1” measured through the use of the second sensor. Thereafter, the controlling unit calculates an amount of liquid crystal which corresponds to the cubage of the retreating area. i.e., which compensates for the shortage of sealant.

The controlling unit may provide to a liquid crystal dispenser (not shown) data on the amount of liquid crystal corresponding to the cubage of the inside retreating area. Accordingly, the liquid crystal dispenser adds to a reference amount of liquid crystal the amount of liquid crystal corresponding to the cubage of the inside retreating area, and then dispenses an adjusted reference amount of liquid crystal within the pattern of paste formed on the substrate. This prevents the liquid crystal from being insufficiently dispensed.

A pattern “P2”, as shown in FIG. 8, has the out-of-specification portion “E2” where the excess of sealant occurs. This phenomenon happens when the distance between the nozzle 36 and the upper surface of the substrate “S” falls short of the predetermined reference distance, In this case, the controlling unit calculates a cubage of an inside protruding area where the sealant would not have been dispensed, based on a cross-sectional area of the out-of-specification portion “E2” measured through the use of the second sensor. Thereafter, the controlling unit calculates an amount of liquid crystal which corresponds to the cubage of the inside protruding area. i.e., which compensates for the excess of sealant.

The controlling unit may provide to a liquid crystal dispenser (not shown) data on the amount of liquid crystal corresponding to the cubage of the inside protruding area. Accordingly, the liquid crystal dispenser subtracts from a reference amount of liquid crystal the amount of liquid crystal corresponding to the cubage of the inside protruding area, and then dispenses an adjusted reference amount of liquid crystal within the pattern of paste formed on the substrate. This prevents the liquid crystal from being insufficiently dispensed. This prevents the liquid crystal from being excessively dispensed, thereby overflowing over the pattern of sealant,

The controlling unit, without calculating the amount of liquid crystal compensating for the shortage or excess of sealant, may provide data on the cubage of the inside retreating area or the cubage of the inside protruding area to the liquid crystal dispenser. In this case, the liquid crystal dispense calculates the cubage of the inside retreating area or the cubage of the inside protruding area, based on the cross-sectional area of the out-of-specification portion “E1” or “E2” measured through the use of the second sensor. Thereafter, the liquid dispenser calculates an amount of liquid crystal which corresponds to the cubage of the inside retreating area or the cubage of the inside protruding area. i.e., which compensates for the shortage or excess of sealant.

Accordingly, the liquid crystal dispenser adds to or subtracts from the reference amount of liquid crystal the amount of liquid crystal corresponding to the cubage of the inside retreating area or the cubage of the inside protruding area, and then dispenses the adjusted reference amount of liquid crystal within the pattern of paste formed on the substrate.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

What is claimed is:

1. A method for calculating an amount of liquid crystal to compensate for any of shortage and excess of sealant dispensed on a substrate, comprising:
putting the substrate on a stage;
dispensing the sealant in a predetermined pattern on the substrate using a dispensing head;
detecting an out-of-specification portion of the pattern of sealant and calculating a cubage of the out-of-specification portion of the pattern of sealant; and
calculating any of shortage and excess of sealant due to the out-of-specification of the pattern of sealant,

2. The method of claim 1, further comprising calculating an amount of liquid crystal to compensate for any of shortage and excess of sealant.

3. The method of claim 2, further comprising providing information on the amount of liquid crystal to compensate for any of shortage and excess of sealant to a liquid crystal dispenser.

4. The method of claim 1, wherein the cubage of the out-of-specification portion of the pattern of sealant is calculated based on data obtained through the use of a second sensor.

5. The method of claim 1, wherein the out-of-specification portion of the pattern of sealant is detected based on data obtained through the use of a first sensor and the cubage of the out-of-specification portion of the pattern of sealant is calculated based on data obtained through the use of a second sensor.

6. The method of claim 4, wherein the cubage of the out-of-specification portion of the pattern of sealant is calculated by calculating a cross-sectional area of the out-of-specification portion of the pattern of sealant and comparing a calculated cross-sectional area of the out-of-specification portion of the pattern of sealant with a reference cross-sectional area.

7. A method for enabling a liquid crystal dispenser to dispense an amount of liquid crystal to compensate for any of shortage and excess of sealant dispensed on a substrate, comprising:
receiving data on any of shortage and excess of sealant dispensed on a substrate;
determining the amount of liquid crystal to compensate for any of shortage and excess of sealant dispensed on a substrate; and
dispensing a determined amount of liquid crystal on an area within a pattern of sealant dispensed on the substrate.

8. The method of claim 7, wherein the data on any of shortage and excess of sealant dispensed on a substrate are expressed in terms of cubage.

9. The method of claim 7, wherein the data on any of shortage and excess of sealant dispensed on a substrate are expressed in terms of weight.
